(19) United States
(12) Patent Application Publication
(10) Pub. No.: US 2021/0104917 A1
(43) Pub. Date: Apr. 8, 2021

(54) ENERGY HARVESTING SYSTEM, APPARATUS AND METHOD FOR PERFORMING WAKEUP

(71) Applicant: KOREA ELECTRONICS TECHNOLOGY INSTITUTE, Seongnam-si (KR)

(72) Inventors: Younghan KIM, Seoul (KR); Hyunseuk AHN, Seongnam-si (KR); Changseok YUN, Yangpyeong-gun (KR)

(21) Appl. No.: 16/666,718

(22) Filed: Oct. 29, 2019

(30) Foreign Application Priority Data
Oct. 4, 2019 (KR) 10-2019-0122755

(51) Int. Cl. H02J 50/20; H02J 50/80; H04W 52/02; H04L 29/08

(52) U.S. Cl. CPC H02J 50/20; H04L 67/12; H04W 52/0229; H02J 50/80

(57) ABSTRACT

An energy harvesting system, apparatus, and method are provided to perform wakeup for a function-performing module while minimizing power consumption. The energy harvesting apparatus performs energy harvesting through a harvesting/wakeup module by receiving RF signals from air when the function-performing module is in a power-off state. If any RF signal containing wakeup information is detected during the energy harvesting, the energy harvesting apparatus wakes up the function-performing module being in the power-off state.

### TECHNICAL FIELD

The present disclosure relates to energy harvesting and, more particularly, to an energy harvesting system, apparatus, and method for performing wakeup with power consumption minimized.

### BACKGROUND

With the growths of Internet of Things (IoT) technologies in a great variety of fields, it is expected that the use of very compact IoT devices of ultra-low-power will increase explosively. However, because such IoT devices need to receive power through a battery or wired power connection to operate, they confront limitations in usable environments and occurrence of maintenance costs. This is a serious obstacle to the proliferation of IoT devices.

In order to solve this issue, what is called a disposable IoT device has been recently introduced. This type IoT device is implemented with very low cost as well as ultra-low power, thus not only performing a default function with limited communication speed but also offering the convenience of easy use and discard.

In addition, to solve a problem caused by the limited battery capacity of IoT devices, there is a demand for the power system technology of IoT devices incorporating the energy harvesting technique that can improve power regeneration and survivability through ambient energy collection and conversion.

Meanwhile, the IoT device that operates in a normal state (mode) performs a given function, such as a communication function, a control function, or a sensing function, with power supplied. After the completion of the given function, the IoT device enters in a standby state (mode) so as to reduce power consumption. Then, the IoT device is activated to the normal state periodically.

Even when the IoT device is in the standby state, power consumption still occurs. Considering the amount of power generated through energy harvesting is merely in the level of micro-watt or nano-watt, the power consumed by the IoT device in the standby state is very large.

### SUMMARY

Accordingly, the present disclosure provides an energy harvesting system, apparatus, and method for performing wakeup with power consumption minimized.

In addition, the present disclosure provides a technique to wake up the energy harvesting apparatus placed in a short range from a user terminal while minimizing power consumption.

According to embodiments of the present disclosure, an energy harvesting apparatus may include a function-performing module woken up in a power-off state and performing a particular function; and a harvesting/wakeup module including an energy harvester performing energy harvesting by converting received radio frequency (RF) signals into electric energy, and a wakeup controller configured to determine whether there is an RF signal containing wakeup information of the function-performing module among the RF signals received during the energy harvesting, and to wake up the function-performing module being in the power-off state when there is the RF signal containing the wakeup information.

The RF signal containing the wakeup information may be a modulated RF signal.

The modulated RF signal may be an RF signal modulated with at least one of time, amplitude, frequency, and phase.

The modulated RF signal may include at least one of a Bluetooth beacon signal, a sinusoidal wave signal, a Zigbee signal, a Wi-Fi signal, an LTE signal, or a 5G NR signal.

A transmission frame of the modulated RF signal may contain a preamble and identification information of the energy harvesting apparatus to be woken up.

When receiving the modulated RF signal, the wakeup controller may be configured to demodulate the wakeup information by tracking an envelope of the received modulated RF signal, to determine whether own identification information is contained in the demodulated wakeup information, and to wake up the function-performing module when the identification information is contained.

The energy harvesting apparatus may further include an electric energy storage receiving the electric energy from the energy harvester and storing the received electric energy.

The harvesting/wakeup module may further include a switch turned on or off to connect or disconnect the function-performing module to or from the electric energy storage, and when there is the RF signal containing the wakeup information, the wakeup controller may turn on the switch to supply the electric energy stored in the electric energy storage to the function-performing module and thereby wake up the function-performing module.

The wakeup controller may maintain a standby state with power of several tens of nW and, when the RF signal containing the wakeup information is applied, may switch to an operating state to perform a data demodulation function.

The function-performing module may include at least one of a controller, a sensor, an RF communication module, and an IoT device.

According to embodiments of the present disclosure, a wakeup method performed by an energy harvesting apparatus may include performing energy harvesting through a harvesting/wakeup module by receiving radio frequency (RF) signals from air and converting the received RF signals into electric energy while a function-performing module is in a power-off state; determining whether there is an RF signal containing wakeup information of the function-performing module among the RF signals received during the energy harvesting; and waking up the function-performing module being in the power-off state through the harvesting/wakeup module when there is the RF signal containing the wakeup information.

The energy harvesting apparatus may receive the RF signal containing the wakeup information from a user terminal positioned in a short range.

The method may further include storing the electric energy in an electric energy storage, wherein waking up the function-performing module is performed by supplying the electric energy stored in the electric energy storage to the function-performing module being in the power-off state.

The energy harvesting may be performed by receiving the RF signals from the user terminal and converting the received RF signals into electric energy.

According to embodiments of the present disclosure, a wakeup method performed by an energy harvesting apparatus may include performing energy harvesting through a harvesting/wakeup module by receiving radio frequency (RF) signals from a user terminal positioned in a short range and converting the received RF signals into electric energy while a function-performing module is in a power-off state; determining whether there is an RF signal containing wakeup information of the function-performing module among the RF signals received from the user terminal during the energy harvesting; and waking up the function-performing module being in the power-off state through the harvesting/wakeup module when there is the RF signal containing the wakeup information.

According to embodiments of the present disclosure, an energy harvesting system may include a user terminal transmitting a radio frequency (RF) signal containing wakeup information for waking up a function-performing module, being in a power-off state, of an energy harvesting apparatus; and the energy harvesting apparatus performing energy harvesting by receiving RF signals from air, and waking up the function-performing module in the power-off state by receiving the RF signal containing the wakeup information from the user terminal during the energy harvesting. In the system, the energy harvesting apparatus may include the function-performing module woken up in the power-off state and performing a particular function; and a harvesting/wakeup module including an energy harvester performing the energy harvesting by converting the received RF signals into electric energy, and a wakeup controller configured to determine whether there is an RF signal containing wakeup information of the function-performing module among the RF signals received from the user terminal during the energy harvesting, and to wake up the function-performing module being in the power-off state when there is the RF signal containing the wakeup information.

The user terminal may transmit the RF signal containing the wakeup information to the energy harvesting apparatus through short-range communication.

According to embodiments of the disclosure, in case of being not in the normal state, the energy harvesting apparatus controls the function-performing module corresponding to the IoT device to be in the power-off state of no power supplied. This can reduce power consumption in the standby state.

As such, the energy harvesting apparatus according to embodiments enables the harvesting/wakeup module to perform the wakeup of the function-performing module being placed in the power-off state. Compared to case of placing the function-performing module in the standby state, this can reduce power consumption. That is, when an RF signal containing wakeup information is received during the energy harvesting, the harvesting/wakeup module of the energy harvesting apparatus can wake up the function-performing module being in the power-off state. The harvesting/wakeup module that performs the energy harvesting and the wakeup has smaller power consumption in comparison with the function-performing module. Also, the harvesting/wakeup module operates in the normal state or the standby state to perform the energy harvesting. Therefore, performing the wakeup of the powered-off function-performing module at the harvesting/wakeup module makes it possible to operate the function-performing module in the power-off state with reduced power consumption rather than in the standby state.

### BRIEF DESCRIPTION OF THE DRAWINGS

FIG. 1 is a block diagram illustrating an energy harvesting system for performing wakeup according to an embodiment of the present disclosure.

FIG. 2 is a block diagram illustrating the energy harvesting apparatus of FIG. 1.

FIG. 3 is an exemplary view showing an encoded data structure of a modulated RF signal.

FIG. 4 is an exemplary view showing a transmission frame of a modulated RF signal.

FIG. 5 is a flow diagram illustrating a wakeup method of an energy harvesting apparatus according to an embodiment of the present disclosure.

FIG. 6 is a flow diagram illustrating a wakeup method of an energy harvesting system according to an embodiment of the present disclosure.

### DETAILED DESCRIPTION

Hereinafter, embodiments of the present disclosure will be described in detail with reference to the accompanying drawings. The present disclosure may, however, be embodied in many different forms and should not be construed as being limited to the embodiments set forth herein. Rather, these embodiments are provided so that the disclosure will be thorough and complete and will fully convey the scope of the disclosure to those skilled in the art.

In the following description of embodiments, techniques that are well known in the art and not directly related to the present disclosure are not described. This is to clearly convey the subject matter of the present disclosure by omitting an unnecessary explanation. For the same reason, some elements in the drawings are exaggerated, omitted, or schematically illustrated. Also, the size of each element does not entirely reflect the actual size. In the disclosure, the same or corresponding elements are denoted by the same reference numerals.

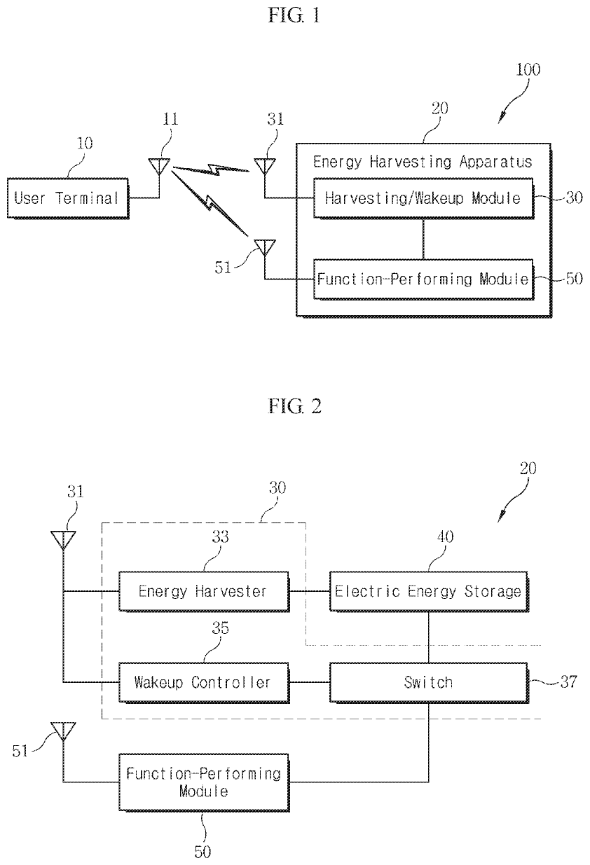

FIG. 1 is a block diagram illustrating an energy harvesting system for performing wakeup according to an embodiment of the present disclosure.

Referring to FIG. 1, an energy harvesting system 100 according to an embodiment includes a user terminal 10 and an energy harvesting apparatus 20. The user terminal 10 transmits a radio frequency (RF) signal to the energy harvesting apparatus 20. This RF signal may be converted into electric energy by the energy harvesting apparatus 20, and a certain RF signal may contain wakeup information for waking up a powered-off function-performing module 50 of the energy harvesting apparatus 20. The energy harvesting apparatus 20 performs the energy harvesting by receiving the RF signal. If the RF signal containing the wakeup information is received from the user terminal 10 during the energy harvesting, the energy harvesting apparatus 20 wakes up powered-off function-performing module 50.

The user terminal 10 may perform specific communication (e.g., short-range communication) with the energy harvesting apparatus 20 through a first antenna 11. Using the specific communication, the user terminal 10 may transmit an RF signal containing wakeup information for waking up the powered-off function-performing module 50. The specific communication may be performed, based on various communication schemes such as, but not limited to, Bluetooth, Bluetooth low energy (BLE), Zigbee, WiFi, long-term evolution (LTE), fifth generation new radio (5G NR), and the like. The user terminal 10 may be one of various kinds of electronic devices capable of performing a communication function, including, for example, a smart phone, a wearable device, a tablet PC, a notebook computer, or the like.

The energy harvesting apparatus 20 includes the function-performing module 50 and a harvesting/wakeup module 30. The function-performing module 50 is usually in a power-off state and, whenever woken up, performs a given function. The harvesting/wakeup module 30 not only performs the energy harvesting by receiving a certain RF signal from the air (i.e., surroundings), but also wakes up the powered-off function-performing module 50 whenever receiving a particular RF signal containing wakeup information from the user terminal 10 during the energy harvesting.

The harvesting/wakeup module 30 receives the RF signal from the air through a second antenna 31 to perform the energy harvesting and the wakeup of the function-performing module 50.

The function-performing module 50 performs a particular function given to the energy harvesting apparatus 20. This function may include a control function, a sensor function for collecting environmental information, a communication function with the user terminal 10, a communication function with surrounding objects, and the like. The function-performing module 50 may be at least one of a controller, a sensor, an RF communication module, and an IoT device. The function-performing module 50 may wake up in the power-off state and communicate with the user terminal 10 through a third antenna 51.

The RF signals received through the second and third antennas 31 and 51 may have the same frequency or different frequencies. Although the second and third antennas 31 and 51 are separately illustrated in this embodiment, they may be alternatively incorporated into a single antenna. In this case, the received RF signal may be sent to the harvesting/wakeup module 30 or the function-performing module 50 through a matching unit.

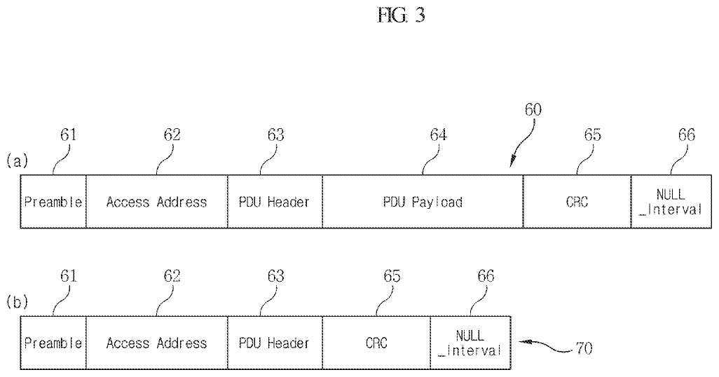

Now, the energy harvesting apparatus 20 according to an embodiment will be described in detail with reference to FIGS. 1 and 2. FIG. 2 is a block diagram illustrating the energy harvesting apparatus 20 of FIG. 1.

The energy harvesting apparatus 20 includes the function-performing module 50 and the harvesting/wakeup module 30 as described above. The harvesting/wakeup module 30 includes an energy harvester 33 and a wakeup controller 35. In addition, the energy harvesting apparatus 20 may further include an electric energy storage 40 and a switch 37.

The function-performing module 50 performs a particular given function in a power-on state which is a normal state. When not performing the given function, the function-performing module 50 switches from the normal state to a power-off state. In the power-off state, the function-performing module 50 is woken up by the harvesting/wakeup module 30 and switches to the normal state to perform the given function. For example, when the function-performing module 50 is an RF communication module, the function-performing module 50 may perform RF communication with a communication device including the user terminal 10 through the third antenna 51.

The energy harvester 33 receives an RF signal from the air through the second antenna 31 and performs the energy harvesting which converts the received RF signal into electric energy. The energy harvester 33 may perform the energy harvesting by receiving the RF signal from the user terminal 10 which is positioned in a short range. The energy harvester 33 may store the electric energy in the electric energy storage 40. In addition, the energy harvester 33 may supply the electric energy to the wakeup controller 35.

The wakeup controller 35 determines whether there is an RF signal containing wakeup information for the function-performing module 50 among RF signals received in the energy harvesting process. If so, the wakeup controller 35 wakes up the function-performing module 50 which is in the power-off state. The wakeup controller 35 may receive such an RF signal containing wakeup information from the user terminal 10 positioned in a short range.

The RF signal containing wakeup information may be a modulated RF signal such that the wakeup controller 35 can easily detect the RF signal containing wakeup information from among received RF signals. The modulated RF signal may be an RF signal modulated with at least one of time, amplitude, frequency, and phase.

The modulated RF signal may be implemented, for example, using a Bluetooth beacon signal or a sinusoidal wave signal in the 2.4 GHz band. Alternatively, the modulated RF signals may be implemented using, for example, but not limited to, a Zigbee signal, a Wi-Fi signal, an LTE signal, or a 5G NR signal.

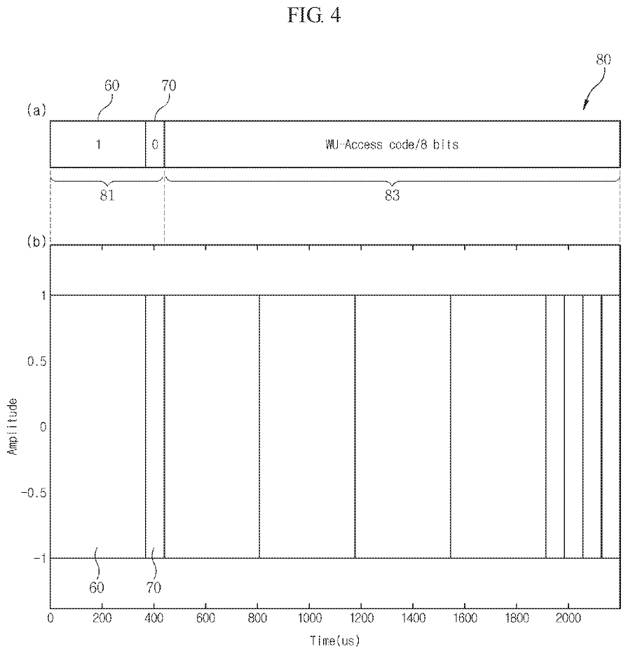

FIGS. 3 and 4 show an example in which the modulated RF signal is implemented using a Bluetooth beacon signal. FIG. 3 is an exemplary view showing an encoded data structure of a modulated RF signal. FIG. 4 is an exemplary view showing a transmission frame of a modulated RF signal.

The modulated RF signal is encoded using a packet and a transmission period of the Bluetooth beacon signal. Specifically, data of the modulated RF signal is encoded using a payload length of packet within one period. For example, while adjusting a payload length, data “1” (indicated by 60) is encoded using a packet length of 376 μs, and data “0” (indicated by 70) is encoded using a packet length of 80 μs.

As shown in FIG. 3, the data packet of the modulated RF signal may contain a preamble 61, an access address 62, a protocol data unit (PDU) header 63, a PDU payload 64, a cyclical redundancy check (CRC) 65, and a null_interval 66 sections.

Specifically, the data packet 60 for data “1” contains all sections of the preamble 61, the access address 62, the PDU header 63, the PDU payload 64, the CRC 65, and the null_interval 66. In particular, the PDU payload 64 contains identification information of the energy harvesting apparatus 20 to be woken up.

In addition, the data packet 70 for data “0” contains sections of the preamble 61, the PDU header 63, the CRC 65, and the null_interval 66, excluding the PDU payload.

As shown in FIG. 4, the transmission frame 80 of the modulated RF signal contains a preamble 81 and identification information 83 of the energy harvesting apparatus 20 to be woken up. For example, the preamble 81 in the transmission frame 80 of the modulated RF signal is composed of data “1” 60 and data “0” 70. Also, the identification information 83 of the energy harvesting apparatus 20 in the transmission frame 80 of the modulated RF signal may be composed of 8 bits, i.e., 4 bits of data “1” 60 and 4 bits of data “0” 70. The identification information 83 of the energy harvesting apparatus 20 may be referred to as a wakeup (WU) access code.

Although FIG. 4 shows an example that the identification information 80 of the energy harvesting apparatus 20 is composed of 8 bits, other examples using 4 bits, 16 bits, 32 bits, etc. may be possible.

When receiving the modulated RF signal as described above, the wakeup controller 35 demodulates the wakeup information by tracking an envelope of the received modulated RF signal. Then, the wakeup controller 35 determines whether its own identification information is contained in the demodulated wakeup information. If so, the wakeup controller 35 wakes up the function-performing module 50 which is in the power-off state. For example, when the modulated RF signal is an amplitude-modulated RF signal, the wakeup controller 35 may demodulate the amplitude-modulated RF signal having the minimum size of −30 dBm.

The harvesting/wakeup module 30 can operate with low power in units of nano-ampere or pico-ampere. Therefore, performing the wakeup of the function-performing module 50 at the harvesting/wakeup module 30 can minimize power consumption due to the wakeup. That is, the wakeup controller 35 maintains a standby state with power of several tens of nW and, when an RF signal having wakeup information is applied, switches to an operating state to perform a data demodulation function.

The electric energy storage 40 receives electric energy from the energy harvester 33 and stores it. The electric energy storage 40 supplies required power to the function-performing module 50 under the control of the wakeup controller 35. The electric energy storage 40 includes at least one of a secondary battery and a super capacitor. The electric energy storage 40 provides required electric energy to the wakeup controller 35.

The switch 37 is turned on or off to connect or disconnect the function-performing module 50 to or from the electric energy storage 40. In the power-off state, the switch 37 disconnects the function-performing module 50 from the electric energy storage 40 to supply no power to the function-performing module 50. When an RF signal having wakeup information is detected, the wakeup controller 35 turns on the switch 37 to supply the electric energy stored in the electric energy storage 40 to the function-performing module 50 and thereby wake up the function-performing module 50.

As described above, in case of being not in the normal state, the energy harvesting apparatus 20 controls the function-performing module 50 corresponding to the IoT device to be in the power-off state of no power supplied. This can reduce power consumption in the standby state.

As such, the energy harvesting apparatus 20 according to embodiments enables the harvesting/wakeup module 30 to perform the wakeup of the function-performing module 50 being placed in the power-off state. Compared to case of placing the function-performing module 50 in the standby state, this can reduce power consumption. That is, when an RF signal containing wakeup information is received during the energy harvesting, the harvesting/wakeup module 30 of the energy harvesting apparatus 20 can wake up the function-performing module 50 being in the power-off state. The harvesting/wakeup module 30 that performs the energy harvesting and the wakeup has smaller power consumption in comparison with the function-performing module 50. Also, the harvesting/wakeup module 30 operates in the normal state or the standby state to perform the energy harvesting. Therefore, performing the wakeup of the powered-off function-performing module 50 at the harvesting/wakeup module 30 makes it possible to operate the function-performing module 50 in the power-off state with reduced power consumption rather than in the standby state.

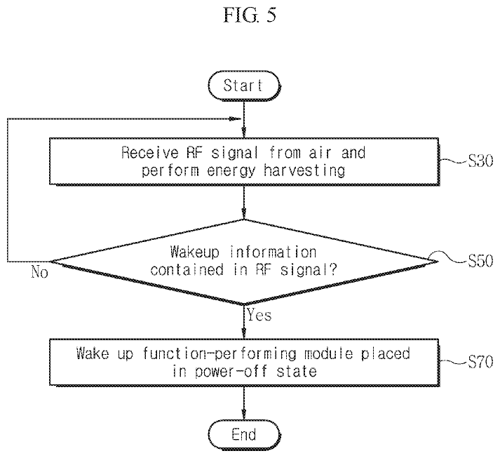

Now, a wakeup method of the energy harvesting apparatus 20 will be described with reference to FIGS. 2 and 5. FIG. 5 is a flow diagram illustrating a wakeup method of an energy harvesting apparatus according to an embodiment of the present disclosure.

At step S30, the energy harvesting apparatus 20 receives an RF signal from the air and performs energy harvesting. At this time, the function-performing module 50 is placed in the power-off state. The energy harvesting apparatus 20 performs the energy harvesting by converting the received RF signal into electric energy through the harvesting/wakeup module 30 while the function-performing module 50 is powered off.

Next, at step S50, the energy harvesting apparatus 20 determines whether there is an RF signal containing wakeup information among the RF signals received through the harvesting/wakeup module 30.

If there is no RF signal containing wakeup information, the energy harvesting apparatus 20 sequentially repeats the steps S30 and S50.

When any RF signal containing wakeup information is found at the step S50, the energy harvesting apparatus 20 wakes up, at step S70, the function-performing module 50 being in the power-off state through the harvesting/wakeup module 30.

Meanwhile, even if there is any RF signal containing wakeup information at the step S50, the energy harvesting apparatus 20 does not perform the wakeup of the powered-off function-performing module 50 when its own identification information is not contained in the wakeup information.

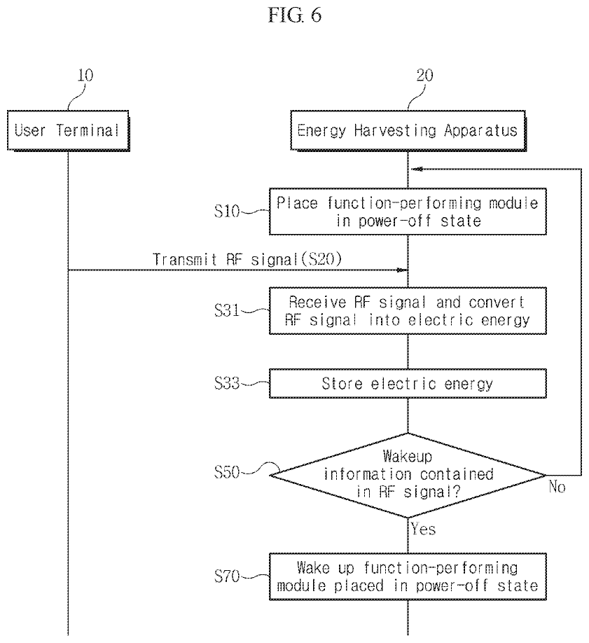

Now, a wakeup method of the energy harvesting system 100 will be described with reference to FIGS. 1, 2, and 6. FIG. 6 is a flow diagram illustrating a wakeup method of an energy harvesting system according to an embodiment of the present disclosure.

At step S10, the energy harvesting apparatus 20 places the function-performing module 50 in the power-off state.

At step S20, the user terminal 10 transmits an RF signal to the energy harvesting apparatus 20 through specific communication such as, e.g., short-range communication.

Then, at step S31, the energy harvesting apparatus 20 receives the RF signal from the user terminal 10 through the harvesting/wakeup module 30 and converts the RF signal into electric energy.

Next, at step S33, the energy harvesting apparatus 20 stores the electric energy in the electric energy storage 40.

In addition, at step S50, the energy harvesting apparatus 20 determines whether, among the RF signals received through the harvesting/wakeup module 30, there is an RF signal containing wakeup information of the function-performing module 50 being in the power-off state.

If it is determined at step S50 that there is no RF signal containing wakeup information, the energy harvesting apparatus 20 returns to the step S10.

If it is determined at step S50 that there is any RF signal containing wakeup information, the energy harvesting apparatus 20 wakes up the function-performing module 50, being currently in the power-off state, through the harvesting/wakeup module 30 at step S70.

While this disclosure has been particularly shown and described with reference to an exemplary embodiment thereof, it will be understood by those skilled in the art that various changes in form and details may be made therein without departing from the scope of the present disclosure as defined by the appended claims.

What is claimed is:

1. An energy harvesting apparatus comprising:
a function-performing module woken up in a power-off state and performing a particular function; and
a harvesting/wakeup module including:
an energy harvester performing energy harvesting by converting received radio frequency (RF) signals into electric energy, and
a wakeup controller configured to determine whether there is an RF signal containing wakeup information of the function-performing module among the RF signals received during the energy harvesting, and to wake up the function-performing module being in the power-off state when there is the RF signal containing the wakeup information.

2. The energy harvesting apparatus of claim 1, wherein the RF signal containing the wakeup information is a modulated RF signal.

3. The energy harvesting apparatus of claim 2, wherein the modulated RF signal is an RF signal modulated with at least one of time, amplitude, frequency, and phase.

4. The energy harvesting apparatus of claim 2, wherein the modulated RF signal includes at least one of a Bluetooth beacon signal, a sinusoidal wave signal, a Zigbee signal, a Wi-Fi signal, an LTE signal, or a 5G NR signal.

5. The energy harvesting apparatus of claim 2, wherein a transmission frame of the modulated RF signal contains a preamble and identification information of the energy harvesting apparatus to be woken up.

6. The energy harvesting apparatus of claim 5, wherein when receiving the modulated RF signal, the wakeup controller is configured to demodulate the wakeup information by tracking an envelope of the received modulated RF signal, to determine whether own identification information is contained in the demodulated wakeup information, and to wake up the function-performing module when the identification information is contained.

7. The energy harvesting apparatus of claim 1, further comprising:
an electric energy storage receiving the electric energy from the energy harvester and storing the received electric energy.

8. The energy harvesting apparatus of claim 7, wherein the harvesting/wakeup module further includes a switch turned on or off to connect or disconnect the function-performing module to or from the electric energy storage, and
wherein when there is the RF signal containing the wakeup information, the wakeup controller turns on the switch to supply the electric energy stored in the electric energy storage to the function-performing module and thereby wake up the function-performing module.

9. The energy harvesting apparatus of claim 1, wherein the wakeup controller maintains a standby state with power of several tens of nW and, when the RF signal containing the wakeup information is applied, switches to an operating state to perform a data demodulation function.

10. The energy harvesting apparatus of claim 1, wherein the function-performing module includes at least one of a controller, a sensor, an RF communication module, and an IoT device.

11. A wakeup method performed by an energy harvesting apparatus, the method comprising:
performing energy harvesting through a harvesting/wakeup module by receiving radio frequency (RF) signals from air and converting the received RF signals into electric energy while a function-performing module is in a power-off state;
determining whether there is an RF signal containing wakeup information of the function-performing module among the RF signals received during the energy harvesting; and
waking up the function-performing module being in the power-off state through the harvesting/wakeup module when there is the RF signal containing the wakeup information.

12. The method of claim 11, wherein the energy harvesting apparatus receives the RF signal containing the wakeup information from a user terminal positioned in a short range.

13. The method of claim 12, further comprising:
storing the electric energy in an electric energy storage,
wherein waking up the function-performing module is performed by supplying the electric energy stored in the electric energy storage to the function-performing module being in the power-off state.

14. The method of claim 12, wherein the energy harvesting is performed by receiving the RF signals from the user terminal and converting the received RF signals into electric energy.

15. A wakeup method performed by an energy harvesting apparatus, the method comprising:
performing energy harvesting through a harvesting/wakeup module by receiving radio frequency (RF) signals from a user terminal positioned in a short range and converting the received RF signals into electric energy while a function-performing module is in a power-off state;
determining whether there is an RF signal containing wakeup information of the function-performing module among the RF signals received from the user terminal during the energy harvesting; and
waking up the function-performing module being in the power-off state through the harvesting/wakeup module when there is the RF signal containing the wakeup information.

16. An energy harvesting system comprising:
a user terminal transmitting a radio frequency (RF) signal containing wakeup information for waking up a function-performing module, being in a power-off state, of an energy harvesting apparatus; and
the energy harvesting apparatus performing energy harvesting by receiving RF signals from air, and waking up the function-performing module in the power-off state by receiving the RF signal containing the wakeup information from the user terminal during the energy harvesting,
wherein the energy harvesting apparatus includes:
the function-performing module woken up in the power-off state and performing a particular function; and
a harvesting/wakeup module including:
an energy harvester performing the energy harvesting by converting the received RF signals into electric energy, and
a wakeup controller configured to determine whether there is an RF signal containing wakeup information of the function-performing module among the RF signals received from the user terminal during the energy harvesting, and to wake up the function-performing module being in the power-off state when there is the RF signal containing the wakeup information.

17. The energy harvesting system of claim 16, wherein the user terminal transmits the RF signal containing the wakeup information to the energy harvesting apparatus through short-range communication.
